(19) United States
(12) Patent Application Publication
(10) Pub. No.: US 2024/0116736 A1
(43) Pub. Date: Apr. 11, 2024

(54) ELEVATOR CONTROL SYSTEM AND METHOD FOR CONTROLLING ELEVATOR

(71) Applicant: Mitsubishi Electric Corporation, Tokyo (JP)

(72) Inventors: Eiji YOKOYAMA, Tokyo (JP); Hidetaka ISHIGURO, Tokyo (JP); Hiroyuki ENOKIJIMA, Tokyo (JP)

(73) Assignee: Mitsubishi Electric Corporation, Tokyo (JP)

(21) Appl. No.: 18/276,882

(22) PCT Filed: Apr. 12, 2021
(86) PCT No.: PCT/JP2021/015193

§ 371 Date: Aug. 11, 2023

(51) Int. Cl. B66B 1/30; B66B 1/34

(52) U.S. Cl. CPC B66B 1/30; B66B 1/3492

(57) ABSTRACT

A position measuring unit detects a present position of a car. A point-of-origin detecting unit detects a passage of the car at a point-of-origin position which is separated by a distance set in advance from a landing position of the car. Each of pattern generating units generates a run pattern based on mutually different algorithms. In each run pattern, an acceleration from before the car passes the point-of-origin position until the car stops is continuous. A pattern selecting unit selects a run pattern which minimizes a landing time as a run pattern which a run control unit causes a run of the car to follow based on a present position. The pattern selecting unit makes the selection based on a speed of the car at a timing when the car passes the point-of-origin position.

### TECHNICAL FIELD

The present disclosure relates to an elevator control system and a method for controlling an elevator.

### BACKGROUND ART

PTL 1 discloses an example of an elevator control device. The control device generates an acceleration command during landing control in accordance with a time lag of a control signal.

### PRIOR ART

### Patent Literature

[PTL 1] Japanese Patent No. 5927838

### SUMMARY OF THE INVENTION

### Problem to be Solved by the Invention

However, the acceleration command generated by the control device according to PTL 1 discontinuously changes after a delay time t_{delay}. Accordingly, ride comfort may decline due to induction of a vibration of a car during landing control.

The present disclosure is related to a solution of such a problem. The present disclosure provides an elevator control system and a method for controlling an elevator which enable a decline in ride comfort due to a vibration of a car during landing control to be suppressed.

### Means to Solve the Problem

An elevator control system according to the present disclosure includes: a position detecting unit which detects a present position of a car in a run direction; a point-of-origin detecting unit which detects passage of the car at a point-of-origin position which is separated by a distance set in advance from a landing position of the car; a plurality of pattern generating units, each of which generates, based on mutually different algorithms, a run pattern from the point-of-origin position to the landing position in which acceleration is continuous from before the car passes the point-of-origin position until the car stops; a run control unit which causes a run of the car to follow a run pattern generated by any of the plurality of pattern generating units based on a present position of the car which is detected by the position detecting unit; and a pattern selecting unit which selects a run pattern that minimizes a landing time required by a run from the point-of-origin position to the landing position as the run pattern which the run control unit causes the run of the car to follow from among the run patterns respectively generated by the plurality of pattern generating units based on a speed of the car at a timing when the point-of-origin detecting unit detects a passage of the car.

A method for controlling an elevator according to the present disclosure includes: a point-of-origin detection step of detecting passage of a car at a point-of-origin position which is separated by a distance set in advance from a landing position of the car; a speed acquisition step of acquiring the speed of the car at a timing when the passage of the point-of-origin position by the car is detected in the point-of-origin detection step; a pattern selection step of selecting a run pattern which minimizes a landing time required by a run from the point-of-origin position to the landing position based on the speed of the car acquired in the speed acquisition step from a plurality of run patterns based on mutually different algorithms from the point-of-origin position to the landing position in which acceleration is continuous from before the car passes the point-of-origin position until the car stops; and a run control step of causing a run of the car to follow the run pattern selected in the pattern selection step based on a present position of the car.

### Effects of the Invention

With the control system or the control method according to the present disclosure, a decline in ride comfort due to a vibration of a car during landing control of an elevator is suppressed.

### BRIEF DESCRIPTION OF DRAWINGS

FIG. 1 is a configuration diagram of an elevator according to a first embodiment.

FIG. 2 is a diagram showing an example of a run pattern in a control system according to the first embodiment.

FIG. 3 is a block diagram showing a configuration of a landing instructing unit according to the first embodiment.

FIG. 4 is a block diagram showing a configuration of a first pattern generating unit according to the first embodiment.

FIG. 5 is a diagram showing an example of a run pattern generated by a constant jerk pattern generating unit according to the first embodiment.

FIG. 6 is a diagram showing an example of a run pattern generated by a compensation pattern generating unit according to the first embodiment.

FIG. 7 is a diagram showing an example of a run pattern generated by the first pattern generating unit according to the first embodiment.

FIG. 8 is a diagram showing an example of a run pattern generated by a second pattern generating unit according to the first embodiment.

FIG. 9 is a diagram showing a relationship between a landing time and a speed of a car in the run pattern generated by the pattern generating unit according to the first embodiment.

FIG. 10 is a diagram showing an example of a run pattern generated by the first pattern generating unit according to the first embodiment.

FIG. 11 is a diagram showing an example of a run pattern generated by the first pattern generating unit according to the first embodiment.

FIG. 12 is a flowchart showing an example of operations of the control system according to the first embodiment.

FIG. 13 is a flowchart showing an example of operations of the control system according to the first embodiment.

FIG. 14 is a flowchart showing an example of operations of the control system according to the first embodiment.

FIG. 15 is a hardware configuration diagram of substantial parts of the control system according to the first embodiment.

FIG. 16 is a configuration diagram of an elevator according to a second embodiment.

### DESCRIPTION OF EMBODIMENTS

Modes for carrying out the object of the present disclosure will be described while referring to the accompanying drawings. Same or corresponding portions in each drawing will be denoted by same reference signs and overlapping descriptions thereof will be simplified or omitted as deemed appropriate. It is to be understood that the object of the present disclosure is not limited to the following embodiments and any of the components of the embodiments can be modified or any of the components of the embodiments can be omitted without departing from the spirit of the present disclosure.

### First Embodiment

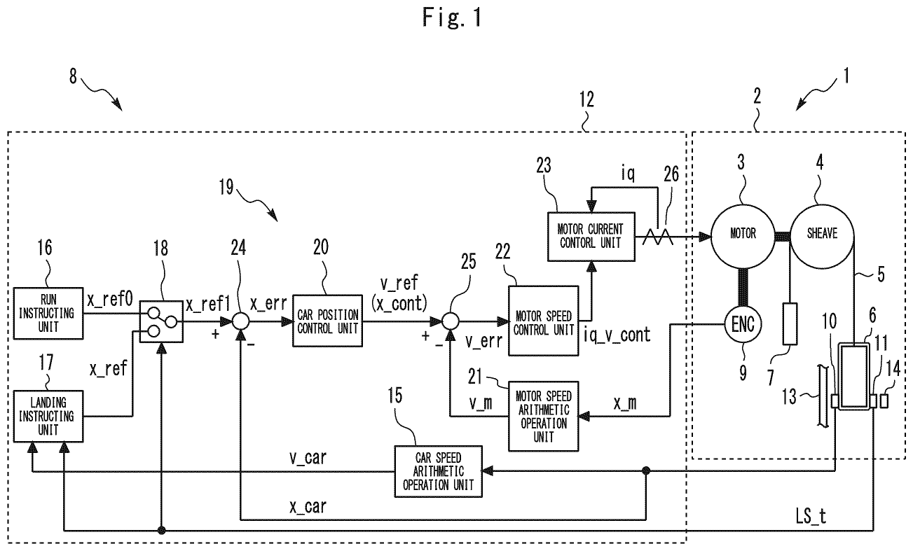

FIG. 1 is a configuration diagram of an elevator 1 according to a first embodiment.

For example, the elevator 1 is applied to a building with a plurality of floors. The building is provided with a hoistway 2 of the elevator 1. The hoistway 2 is a vertically-long space which extends across a plurality of floors. The elevator 1 includes a motor 3, a sheave 4, a main rope 5, a car 6, and a counterweight 7.

For example, the motor 3 is provided in an upper part or a lower part of the hoistway 2. For example, when a machine room of the elevator 1 is provided in the upper part of the hoistway 2, the motor 3 may be arranged in the machine room. The sheave 4 is connected to a rotary shaft of the motor 3. The main rope 5 is wound around the sheave 4. The main rope 5 supports a load of the car 6 on one side of the sheave 4. The main rope 5 supports a load of the counterweight 7 on another side of the sheave 4. The car 6 is a device which carries users or the like among a plurality of floors by running in the hoistway 2 in the vertical direction. The counterweight 7 is a device which balances, with the car 6, the loads applied to both side of the sheave 4 through the main rope 5. The car 6 and the counterweight 7 run in mutually opposite directions in the hoistway 2 in conjunction with the main rope 5 which moves as the motor 3 rotationally drives the sheave 4.

The elevator 1 includes a control system 8. The control system 8 is a system which controls motion of the elevator 1. The control system 8 includes an encoder 9, a position measuring unit 10, a point-of-origin detecting unit 11, and a control device 12.

The encoder 9 is a device which detects a rotation angle of the motor 3. The encoder 9 is mounted to the motor 3. The encoder 9 outputs a signal of a detected rotation angle_x_m of the motor 3 to the control device 12.

The position measuring unit 10 is a unit which detects a present position of the car 6 in a run direction by measurement. The position measuring unit 10 is an example of the position detecting unit. In this example, the position measuring unit 10 is a sensor of an APS (Absolute Positioning System). The position measuring unit 10 is provided in the car 6. With respect to the position measuring unit 10, a code tape 13 of the APS is provided along the vertical direction in the hoistway 2. The code tape 13 is a tape indicating an image created by encoding information representing positions in the vertical direction. The position measuring unit 10 detects the present position of the car 6 by reading information on the code tape 13. The position measuring unit 10 outputs a signal of a detected present position x_car of the car 6 to the control device 12.

The point-of-origin detecting unit 11 is a unit which detects passage of the car 6 at a point-of-origin position. The point-of-origin detecting unit 11 is provided in the car 6. The point-of-origin position is a position determined in advance in the run direction of the car 6. The point-of-origin position is set in plurality. In this example, the point-of-origin position is set at a point separated by a distance set in advance from a landing position of each floor. At the point-of-origin position of each floor, a detection object 14 is provided in the hoistway 2. The detection object 14 is, for example, a landing plate. When the car 6 passes any of the point-of-origin positions, the point-of-origin detecting unit 11 detects passage of the point-of-origin position by detecting the detection object 14 provided at the point-of-origin position. The point-of-origin detecting unit 11 outputs a detection signal LS_t to the control device 12 upon detecting passage of a point-of-origin position.

The control device 12 is a device which performs processing of control and the like in the elevator 1. For example, the control device 12 is constructed on an electric board or the like. The control device 12 may be constituted of a plurality of devices. For example, a part of or all of the control device 12 is provided in an upper part or a lower part of the hoistway 2. Alternatively, when a machine room of the elevator 1 is provided, a part of or all of the control device 12 may be arranged in the machine room. The control device 12 controls a run of the car 6 using a plurality of control modes. The control modes include an interfloor running mode and a landing mode. The interfloor running mode is a control mode when the car 6 runs between a departure floor and a destination floor. The landing mode is a control mode when the car 6 lands at a landing position of the destination floor. The control mode in the control device 12 is switched from the interfloor running mode to the landing mode when, for example, the car 6 passes the point-of-origin position which corresponds to the landing position of the destination floor. The control device 12 includes a car speed arithmetic operation unit 15, a run instructing unit 16, a landing instructing unit 17, a control mode switching unit 18, and a run control unit 19.

The car speed arithmetic operation unit 15 performs an arithmetic operation of a speed of the car 6 by time differentiation or the like based on the signal of the present position x_car of the car 6 which is input from the position measuring unit 10. The car speed arithmetic operation unit 15 outputs a signal of a calculated speed v_car of the car 6.

The run instructing unit 16 is a unit which generates a run pattern of the car 6 which runs between the departure floor and the destination floor or, in other words, a run pattern in the interfloor running mode. For example, a run pattern is a waveform or the like which represents a value at each time of day of a position, a speed, an acceleration, a jerk, or the like of the car 6. In this example, the run pattern is a waveform of the position of the car 6. The run pattern in the interfloor running mode includes an acceleration run and a deceleration run. An acceleration run is a run with constant acceleration which causes an absolute value of speed to increase when the car 6 departs from the departure floor. A deceleration run is a run with constant acceleration which causes an absolute value of speed to decrease when the car 6 arrives at the destination floor. Run patterns may include, between an acceleration run and a deceleration run, a constant-speed run of which a speed is constant. The run instructing unit 16 outputs a signal representing a run pattern x_ref0 in the interfloor running mode.

The landing instructing unit 17 is a unit which generates a run pattern of the car 6 when landing at a landing position of the destination floor or, in other words, a run pattern in the landing mode. At this point, the control mode is switched to the landing mode during the deceleration run in the interfloor running mode. The landing instructing unit 17 acquires the speed of the car 6 based on the signal of the speed v_car which is output by the car speed arithmetic operation unit 15. The landing instructing unit 17 judges a timing of passage of the car 6 at the point-of-origin position corresponding to the landing position of the destination floor based on the detection signal LS_t which is output by the point-of-origin detecting unit 11. The landing instructing unit 17 generates a run pattern in the landing mode based on the speed of the car 6 when the car 6 passes the point-of-origin position. The landing instructing unit 17 outputs a signal representing a run pattern x_ref in the landing mode.

The control mode switching unit 18 is a unit which switches control modes in the control device 12. The control mode switching unit 18 outputs, as a signal of a run pattern x_ref1, a run pattern in accordance with the control mode in the control device 12 among input run patterns such as the run pattern x_ref0 from the run instructing unit 16 and the run pattern x_ref from the landing instructing unit 17. The control mode switching unit 18 switches the control mode to the interfloor running mode when the car 6 departs from the departure floor toward the destination floor. At this point, the control mode switching unit 18 outputs, as the signal of the run pattern x_ref1 in accordance with the control mode, the run pattern x_ref0 from the run instructing unit 16. The control mode switching unit 18 judges a timing of passage of the car 6 at the point-of-origin position corresponding to the landing position of the destination floor based on the detection signal LS_t output by the point-of-origin detecting unit 11. The control mode switching unit 18 switches the control mode from the interfloor running mode to the landing mode when the car 6 passes the point-of-origin position. At this point, the control mode switching unit 18 outputs, as the signal of the run pattern x_ref1 in accordance with the control mode, the run pattern x_ref from the landing instructing unit 17.

The run control unit 19 is a unit which causes a run of the car 6 to follow a run pattern in accordance with the control mode. The run control unit 19 includes a car position control unit 20, a motor speed arithmetic operation unit 21, a motor speed control unit 22, and a motor current control unit 23.

The car position control unit 20 is a unit which causes a position of the car 6 to follow a run pattern in accordance with the control mode. The car position control unit 20 outputs a control signal x_cont for causing the run of the car 6 to follow the run pattern based on a difference between a position in the run pattern and the position of the car 6. In this example, the car position control unit 20 receives a signal representing a difference x_err between the run pattern x_ref1 which the run of the car 6 is caused to follow and the present position x_car of the car 6 which is detected by the position measuring unit 10 from a subtractor 24 which calculates the difference. In this example, the car position control unit 20 outputs a signal representing an angular speed target v_ref of the motor 3 as the control signal x_cont.

The motor speed arithmetic operation unit 21 calculates the angular speed of the motor 3 based on a signal of the rotation angle_x_m of the motor 3 which is input from the encoder 9. The motor speed arithmetic operation unit 21 outputs a signal of the calculated angular speed v_m of the motor 3.

The motor speed control unit 22 is a unit which causes the angular speed of the motor 3 to follow the angular speed target. The motor speed control unit 22 receives a signal representing a difference v_err between the angular speed target v_ref which is output by the car position control unit 20 and the angular speed v_m of the motor 3 which is calculated by the motor speed arithmetic operation unit 21 from the subtractor 25 which calculates the difference. The motor speed control unit 22 outputs a signal representing a torque current target iq_v_cont of the motor 3 by performing control arithmetic operations such as proportionality, integration, and differentiation based on the signal of the difference v_err so that necessary performance of the motor 3 can be obtained in a stable manner.

The motor current control unit 23 supplies the motor 3 with a drive current in accordance with the input signal of the torque current target iq_v_cont. The motor current control unit 23 receives a signal representing a current iq which is detected by a current detector 26 provided in the motor 3 from the current detector 26. The motor current control unit 23 receives feedback of the signal of the current iq from the current detector 26 and supplies a current so that the drive current of the motor 3 matches the torque current target iq_v_cont.

In this manner, a speed control system is realized which causes the angular speed v_m of the motor 3 to follow the angular speed target v_ref so that a difference v_err in speed is within a range set in advance. In addition, a position control system is realized which causes the position x_car of the car 6 to follow the run pattern x_ref1 being a position target of the car 6 so that a difference x_err in position is within a range set in advance. By causing the angular speed target v_ref to be output as the control signal x_cont, control in which the difference x_err in position converges to 0 is performed. In this case, the position of the car 6 follows the run pattern x_ref1 without error. In particular, when a configuration of the car position control unit 20 is considered integral compensation, since the present control is a position control loop of type one control, control deviation no longer increases even when there is an observation delay of position information of the car 6.

In the detection of the position of the car 6 by the APS, an error may arise depending on a temperature of a use environment. In order to compensate for such an error, a measuring instrument which constantly measures a relative amount of elongation or contraction due to the temperature between the code tape 13 of the APS and the building may be provided in a lower end part of the hoistway 2 or the like. On the other hand, such a measuring instrument may result in increasing the cost of the control system 8 of the elevator 1. Even when the present position of the car 6 which is detected by the position measuring unit 10 includes an error, the control system 8 performs landing control which compensates for the error without the need for a measuring instrument or the like for constantly measuring a relative amount of elongation or contraction due to the temperature between the code tape 13 of the APS and the building.

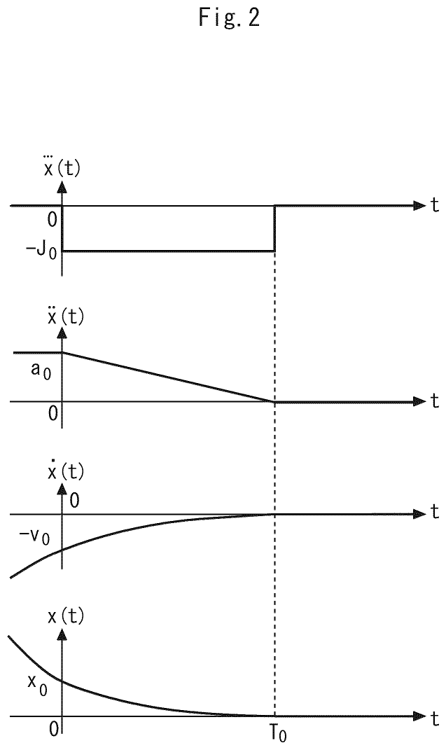

Next, an example of a run pattern in an ideal case or, in other words, in a case where the present position of the car 6 which is detected by the position measuring unit 10 does not include an error will be described with reference to FIG. 2.

FIG. 2 is a diagram showing an example of a run pattern in the control system 8 according to the first embodiment.

In this case, an example of a run pattern when running downward from a departure floor and landing on a destination floor is shown. The example of the run pattern is indicated by four graphs. In each graph, an axis of abscissa represents time. An origin of time is set to a time of day at which the car 6 passes a point-of-origin position which corresponds to a landing position of the destination floor. In the bottommost graph, an axis of ordinate represents a position of the car 6. An origin of position is set to the landing position of the destination floor of the car 6. In the second graph from bottom, an axis of ordinate represents a speed of the car 6. In the third graph from bottom, an axis of ordinate represents an acceleration of the car 6. Prior to a time of day 0, the car 6 runs according to a deceleration run in the interfloor running mode. At this point, a magnitude of acceleration is a constant value set in advance. In the fourth graph from bottom, an axis of ordinate represents a jerk of the car 6. In this example, a waveform of speed, a waveform of acceleration, and a waveform of jerk are not output as a signal of the run pattern in the control system 8.

At the time of day 0, the position of the car 6 is x₀ [m] which is a position of the detection object 14 provided at the point-of-origin position corresponding to the landing position of the destination floor. In addition, the acceleration of the car 6 at this timing is a constant value a₀ [m/s²] set in advance. In the run pattern generated in this case, an acceleration of the car 6 maintains continuity before and after passage of the point-of-origin position. In addition, the run pattern maintains a constant jerk until the car 6 stops at the landing position. Favorable ride comfort is secured due to the car 6 decelerating at a constant jerk. From this condition, a speed −v₀ [m/s], a landing time T₀ [s], and a constant jerk −J₀ [m/s³] of the car 6 at a timing when the car 6 passes the point-of-origin position are represented by expression (1) to expression (3) below, where the landing time represents a time required by a run from the point-of-origin position to the landing position.

$$\begin{matrix}[ Math . 1 ] & \\ {v}_{0} = \sqrt{\frac{3 {x}_{0} {a}_{0}}{2} .} & ( 1 )\end{matrix}$$

$$\begin{matrix}[ Math . 2 ] & \\ {T}_{0} = \frac{2 {v}_{0}}{{a}_{0}} . & ( 2 )\end{matrix}$$

$$\begin{matrix}[ Math . 3 ] & \\ {J}_{0} = \frac{{a}_{0}}{{T}_{0}} . & ( 3 )\end{matrix}$$

Expression (1) to expression (3) indicate that, when the present position of the car 6 which is detected by the position measuring unit 10 does not include an error, once the position x₀ [m] of the detection object 14 provided at the point-of-origin position and the acceleration a₀ [m/s²] of the car 6 at a timing of passing the point-of-origin position are determined, the speed −v₀ [m/s], the jerk −J⁰ [m/s³], and the landing time T₀ [s] of the car 6 at the timing are uniquely determined. In this case, in a deceleration run, the speed of the car 6 monotonically decreases. Therefore, when the present position of the car 6 which is detected by the position measuring unit 10 includes an error, the car 6 is to pass the point-of-origin position at a timing when the car 6 is running at a speed which differs from the speed −v₀ [m/s] represented by expression (1). Since a speed −vₛ [m/s] at the timing when the car 6 passes the point-of-origin position differs from the speed −v₀ [m/s], applying the run pattern shown in FIG. 2 as it is may result in creating a landing error. The landing instructing unit 17 performs landing control which compensates for the error in the present position of the car 6 which is detected by the position measuring unit 10.

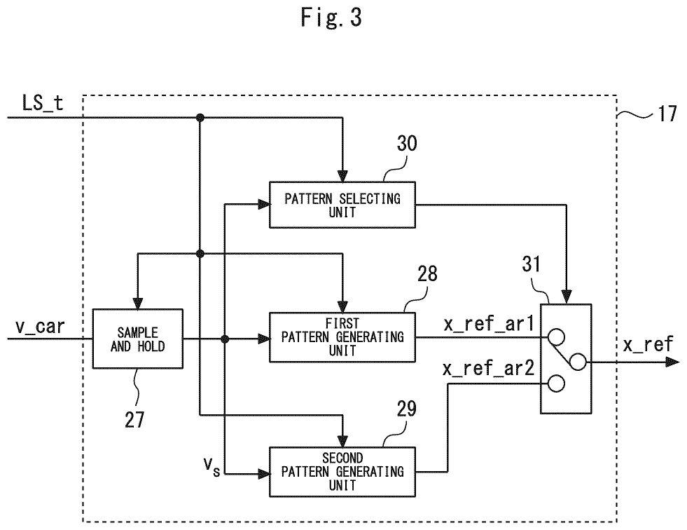

FIG. 3 is a block diagram showing a configuration of the landing instructing unit 17 according to the first embodiment.

The landing instructing unit 17 includes a sample and hold 27, a first pattern generating unit 28, a second pattern generating unit 29, a pattern selecting unit 30, and a pattern switching unit 31.

The sample and hold 27 judges a timing of passage of the car 6 at the point-of-origin position corresponding to the landing position of a target floor based on the detection signal LS_t output by the point-of-origin detecting unit 11. The sample and hold 27 acquires the speed −vₛ [m/s] of the car 6 when the car 6 passes the point-of-origin position based on a signal of v_car which is output by the car speed arithmetic operation unit 15.

Each of the first pattern generating unit 28 and the second pattern generating unit 29 is an example of the plurality of pattern generating units. Each pattern generating unit is a unit which generates a run pattern from the point-of-origin position to the landing position based on mutually different algorithms. Each pattern generating unit generates a waveform of the position of the car 6 as a run pattern so that the acceleration of the car 6 continues from immediately before passing the point-of-origin position until the car 6 stops. The first pattern generating unit 28 outputs the generated waveform of the position as a signal of a run pattern x_ref_ar1. The second pattern generating unit 29 outputs the generated waveform of the position as a signal of a run pattern x_ref_ar2.

The pattern selecting unit 30 is a unit which selects a run pattern to be output from the landing instructing unit 17 as the run pattern x_ref from the run patterns generated by the respective pattern generating units. In this case, the run pattern output from the landing instructing unit 17 is output as a signal of the run pattern x_ref1 in the landing mode. Therefore, the run pattern selected by the pattern selecting unit 30 is a run pattern which the run control unit 19 causes the run of the car 6 to follow in the landing mode. The pattern selecting unit 30 selects a run pattern which minimizes a landing time among the run patterns generated by the respective pattern generating units.

The pattern switching unit 31 is a unit which switches a run pattern to be output as the run pattern x_ref based on the selection by the pattern selecting unit 30 from among the run patterns generated by the respective pattern generating units.

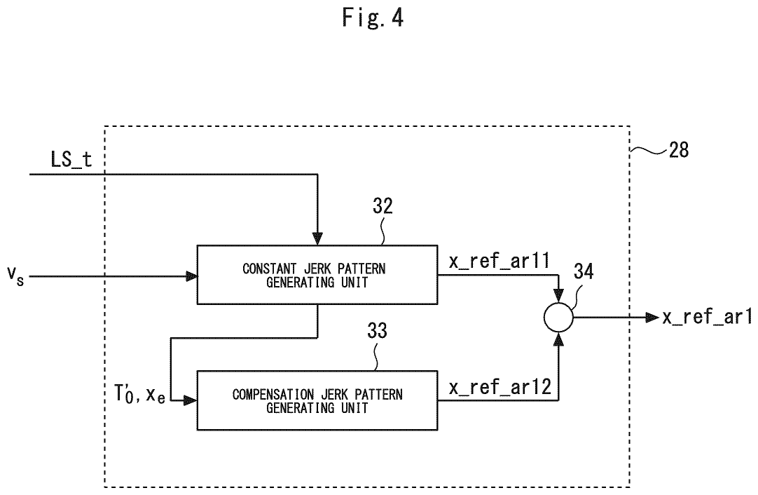

FIG. 4 is a block diagram showing a configuration of the first pattern generating unit 28 according to the first embodiment.

The first pattern generating unit 28 includes a constant jerk pattern generating unit 32 and a compensation pattern generating unit 33.

The constant jerk pattern generating unit 32 is a unit which generates a run pattern in which jerk is constant. The constant jerk pattern generating unit 32 generates a waveform of the position of the car 6 as a run pattern. The constant jerk pattern generating unit 32 outputs the generated waveform of the position of the car 6 as a signal of a run pattern x_ref_ar11. The constant jerk pattern generating unit 32 generates a run pattern which adopts the speed −vₛ [m/s] acquired by the sample and hold 27 as an initial speed, in which the acceleration of the car 6 maintains continuity before and after passing the point-of-origin position, and which maintains a constant jerk until the car 6 stops. The speed −vs [m/s] in this case may differ from the speed −v₀ [m/s] represented by expression (1). From a relationship similar to that represented by expression (1) to expression (3), once the acceleration a₀ [m/s²] of the car 6 at a timing of passing the point-of-origin position and the speed −vs [m/s] of the car 6 at the timing are determined, the jerk −J₀ [m/s³], the landing time T₀ [s], and the distance x′₀ [m] which the car 6 runs until the car 6 stops are uniquely determined. Therefore, when the speed −vₛ [m/s] and the speed −v₀ [m/s] differ from each other, a running distance x′₀ [m] of the car 6 does not match a distance x₀ [m] between the point-of-origin position and the landing position. As a result, a landing error which is precisely a difference xₑ [m] between the distance x′₀ [m] and the distance x₀ [m] is created.

The compensation pattern generating unit 33 is a unit which generates a run pattern to compensate for a landing error in the run pattern generated by the constant jerk pattern generating unit 32. The compensation pattern generating unit 33 generates a waveform of the position of the car 6 as a run pattern. The compensation pattern generating unit 33 outputs the generated waveform of the position of the car 6 as a signal of a run pattern x_ref_ar12. The compensation pattern generating unit 33 generates a run pattern to compensate for the landing error within a landing time in the run pattern generated by the constant jerk pattern generating unit 32.

The first pattern generating unit 28 superimposes the run pattern x_ref_ar11 generated by the constant jerk pattern generating unit 32 and the run pattern x_ref_ar12 generated by the compensation pattern generating unit 33 on each other by synchronizing times of day and adding the run patterns in an adder 34. The first pattern generating unit 28 outputs a signal of the superimposed run pattern x_ref_ar1.

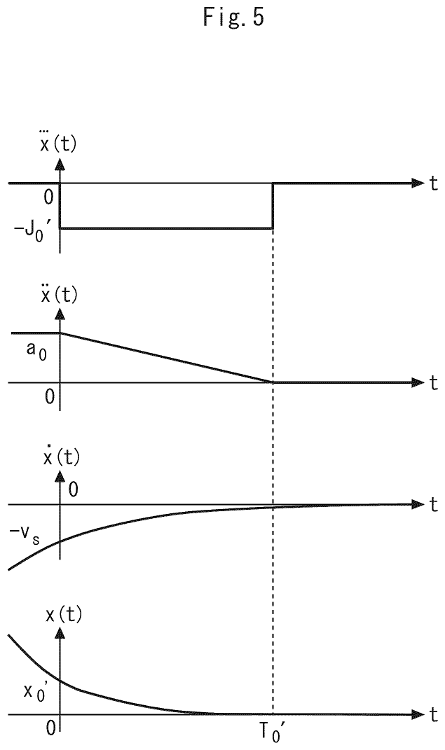

Next, an example of a run pattern generated by the first pattern generating unit 28 will be described with reference to FIG. 5 to FIG. 7.

FIG. 5 is a diagram showing an example of a run pattern generated by the constant jerk pattern generating unit 32 according to the first embodiment.

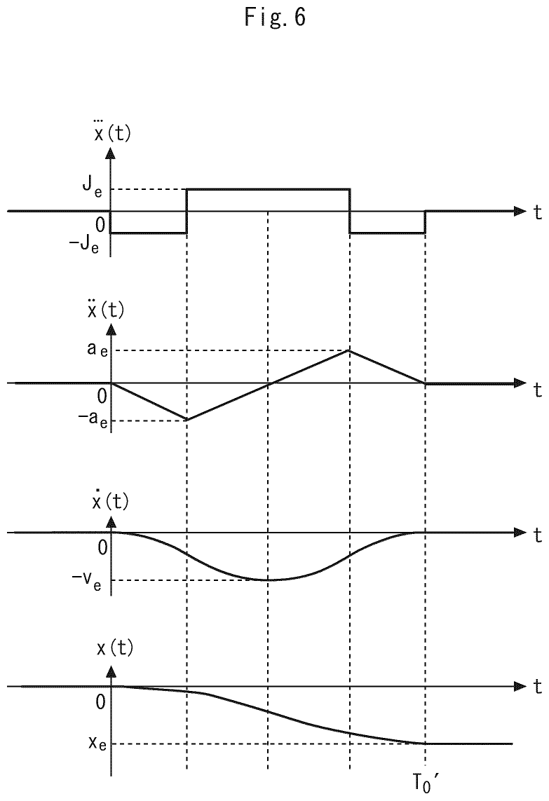

FIG. 6 is a diagram showing an example of a run pattern generated by the compensation pattern generating unit 33 according to the first embodiment.

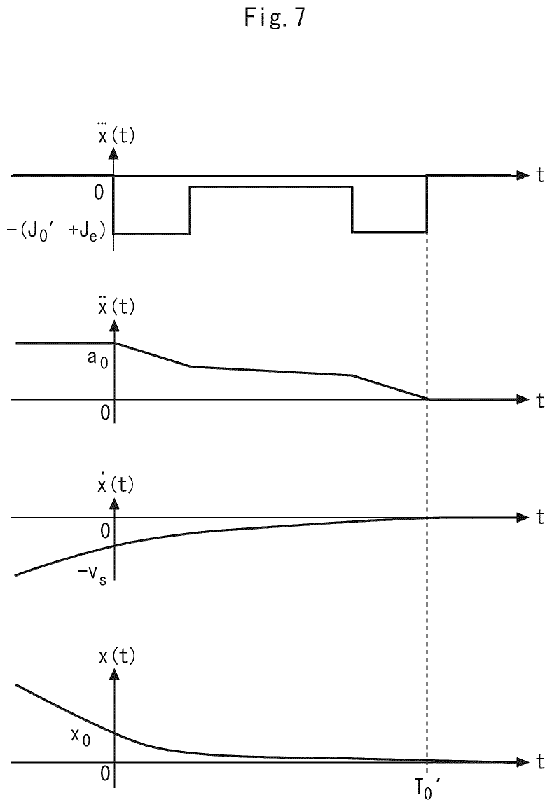

FIG. 7 is a diagram showing an example of a run pattern generated by the first pattern generating unit 28 according to the first embodiment.

FIG. 5 shows an example of a run pattern generated by the constant jerk pattern generating unit 32 in which jerk is constant. In this run pattern, after passing the point-of-origin position, the car 6 stops after running for the distance x′₀ [m] within a landing time T′₀ [s]. The landing time T′₀ [s] is represented by expression (4) below in a similar manner to expression (2).

$$\begin{matrix}[ Math . 4 ] & \\ {T}_{0}^{′} = \frac{2 {v}_{s}}{{a}_{0}} . & ( 4 )\end{matrix}$$

In addition, the running distance x′₀ [m] of the car 6 is represented by expression (5) below.

$$\begin{matrix}[ Math . 5 ] & \\ {x}_{0}^{′} = \frac{{a}_{0}}{6} {T}_{0}^{′2} . & ( 5 )\end{matrix}$$

The run pattern x_ref_ar11 generated by the constant jerk pattern generating unit 32 is represented by expression (6) below as a cubic function of time t [s].

$$\begin{matrix}[ Math . 6 ] & \\ x\_ref \_ar11 ( t ) = \frac{{a}_{0}}{6 {T}_{0}^{′}} {( {T}_{0}^{′} - t )}^{3} . & ( 6 )\end{matrix}$$

In this case, since the point-of-origin position is actually separated from the landing position by the distance x₀ [m], a landing error xₑ [m] represented by expression (7) below is created.

[Math. 7]

xₑ=x₀−x′₀. (7)

FIG. 6 shows an example of a run pattern which is generated by the compensation pattern generating unit 33 and which compensates for the landing error in expression (7). In the run pattern generated by the compensation pattern generating unit 33, within the landing time T′₀ [s] of the run pattern generated by the constant jerk pattern generating unit 32, the car 6 stops after running for a distance −x′₀ [m]. In the run pattern, a period until the landing time T′₀ [s] elapses is divided into three periods: a first period, a second period, and a third period. The first period is a period from the car 6 passing the point-of-origin position until ¼ of the landing time T′₀ [s] elapses. The second period is a period from the end of the first period until ½ of the landing time T′₀ [s] elapses. The third period is a period from the end of the second period until ¼ of the landing time T′₀ [s] elapses.

In the run pattern generated by the compensation pattern generating unit 33 in this example, an integrated value of jerk over the time T′₀ [s] is 0. In the run pattern, the jerk is set to a piecewise-constant value. In the run pattern, the jerk is set to a constant value in each of the first period, the second period, and the third period. A direction of the jerk in the first period is set to a direction which compensates for the landing error. A direction of the jerk in the second period is set to an opposite direction to the jerk in the first period. A direction of the jerk in the third period is set to a same direction as the jerk in the first period. Absolute values of the jerk in the respective periods including the first period, the second period, and the third period are set to same magnitudes.

In the run pattern generated by the compensation pattern generating unit 33 in this example, an integrated value of acceleration over the time T′₀ [s] is 0. In the run pattern, the acceleration at a timing when the car 6 passes the point-of-origin position is set to 0. In the run pattern, the speed at a timing when the car 6 passes the point-of-origin position is set to 0.

From these conditions, the run pattern x_ref_ar12 generated by the compensation pattern generating unit 33 in the first period is represented by expression (8) below as a cubic function of time t [s].

$$\begin{matrix}[ Math . 8 ] & \\ x\_ref \_ar12 ( t ) = \frac{1}{6} {J}_{e} {t}^{3} , ( 0 \leq t < \frac{1}{4} {T}_{0}^{′} ) . & ( 8 )\end{matrix}$$

In this case, an absolute value Je [m/s³] of the jerk in the first period, the second period, and the third period is set so that the car 6 runs by a distance −x′₀ [m] until the landing time T′₀ [s] elapses. The absolute value Je [m/s³] of the jerk is represented by expression (9) below.

$$\begin{matrix}[ Math . 9 ] & \\ {J}_{e} = \frac{32}{{T}_{0}^{′3}} {x}_{e} . & ( 9 )\end{matrix}$$

In addition, the run pattern x_ref_ar12 generated by the compensation pattern generating unit 33 in the second period is represented by expression (10) below as a cubic function of time t [s].

$$\begin{matrix}[ Math . 10 ] & \\ x\_ref \_ar12 ( t ) = - \frac{1}{6} {J}_{e} {t}^{3} + \frac{1}{4} {J}_{e} {T}_{0}^{′} {t}^{2} - \frac{1}{16} {J}_{e} {T}_{0}^{′2} t + \frac{1}{192} {J}_{e} {T}_{0}^{′3} , ( \frac{1}{4} {T}_{0}^{′} \leq t < \frac{3}{4} {T}_{0}^{′} ) . & ( 10 )\end{matrix}$$

In addition, the run pattern x_ref_ar12 generated by the compensation pattern generating unit 33 in the third period is represented by expression (11) below as a cubic function of time t [s].

$$\begin{matrix}[ Math . 11 ] & \\ x\_ref \_ar12 ( t ) = \frac{1}{6} {J}_{e} {t}^{3} - \frac{1}{2} {J}_{e} {T}_{0}^{′} {t}^{2} + \frac{1}{2} {J}_{e} {T}_{0}^{′2} t - \frac{1}{6} {J}_{e} {T}_{0}^{′3} + {x}_{e} , ( \frac{3}{4} {T}_{0}^{′} \leq t < {T}_{0}^{′} ) . & ( 11 )\end{matrix}$$

FIG. 7 shows an example of a run pattern generated by the first pattern generating unit 28. In generating the run pattern, the first pattern generating unit 28 superimposes the run pattern x_ref_ar11 generated by the constant jerk pattern generating unit 32 and the run pattern x_ref_ar12 generated by the compensation pattern generating unit 33 on each other. In other words, a position x_ref_ar1 of the car 6 in the run pattern generated by the first pattern generating unit 28 is represented by expression (12) below as a function of time t [s].

[Math. 12]

x_ref_ar1(t)=x_ref_ar11(t)+x_ref_ar12(t). (12)

As described above, in the run pattern generated by the first pattern generating unit 28, continuity of the acceleration, the speed, and the position of the car 6 is maintained before and after the control mode is switched from the interfloor running mode to the landing mode and between landing modes. Therefore, a vibration of the car 6 during landing control is less likely to be induced. In addition, since a landing error is compensated by the run pattern generated by the compensation pattern generating unit 33, a running distance between landing modes in the run pattern generated by the first pattern generating unit 28 is x₀ [m]. Furthermore, the landing time of the run pattern generated by the first pattern generating unit 28 matches the landing time T′₀ [s] of the run pattern generated by the constant jerk pattern generating unit 32.

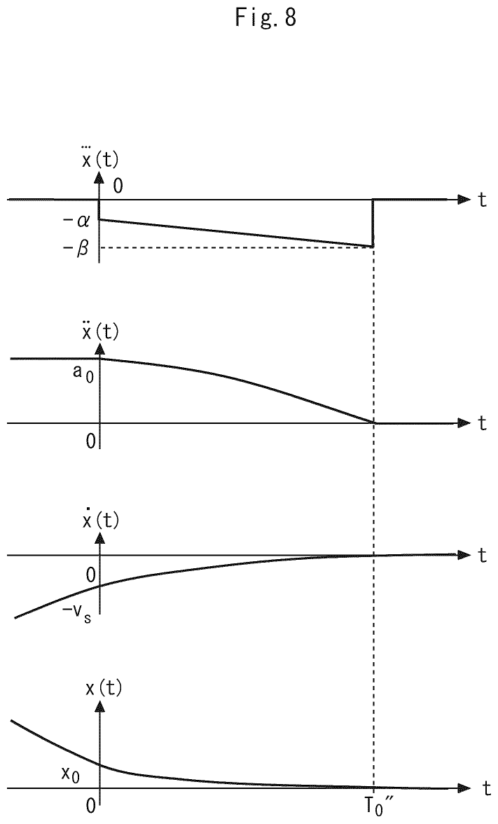

Next, an example of a run pattern generated by the second pattern generating unit 29 will be described with reference to FIG. 8.

FIG. 8 is a diagram showing an example of a run pattern generated by the second pattern generating unit 29 according to the first embodiment.

The second pattern generating unit 29 generates a run pattern in which an absolute value of jerk increases as a linear function of time until the car 6 stops. In the run pattern, a snap which is a time derivative of the jerk is kept constant until the car 6 stops. The run pattern is set by two parameters being a jerk −α [m/s³] at a timing when the car 6 passes the point-of-origin position and a jerk −β [m/s³] at a timing when the car 6 stops. In other words, there is one more parameter as compared to a run pattern with a constant jerk. Therefore, once the running distance x₀ [m] of the car 6 in addition to the acceleration a₀ [m/s²] of the car 6 at a timing of passing the point-of-origin position and a speed −vₛ [m/s] of the car 6 at the timing are determined, a landing time T″₀ [s] and the two parameters α [m/s³] and β [m/s³] are uniquely determined.

At the time of day 0, the position of the car 6 is x₀ [m] which is a position of the detection object 14 provided at the point-of-origin position corresponding to the landing position of the destination floor. In other words, in order to prevent a landing error from being created, the distance which the car 6 runs before stopping must be x₀ [m]. In addition, the acceleration of the car 6 at the timing when the car 6 passes the point-of-origin position is a constant value a₀ [m/s²] set in advance with respect to a deceleration period so that continuity is maintained before and after passage of the point-of-origin position. Furthermore, the speed of the car 6 at this timing is the speed −vₛ [m/s] acquired by the sample and hold 27. From these conditions, the landing time T″₀ [s] and the two parameters α [m/s³] and β [m/s³] are represented by expression (13) to expression (15) below.

$$\begin{matrix}[ Math . 13 ] & \\ {T}_{0}^{′′} = \frac{3 {v}_{s} - \sqrt{9 {v}_{s}^{2} - 12 {a}_{0} {x}_{0}}}{{a}_{0}} . & ( 13 )\end{matrix}$$

$$\begin{matrix}[ Math . 14 ] & \\ β = \frac{2 ( 3 {v}_{s} - {a}_{0} {T}_{0}^{′′} )}{{T}_{0}^{′′2}} . & ( 14 )\end{matrix}$$

$$\begin{matrix}[ Math . 15 ] & \\ α = \frac{2 {a}_{0}}{{T}_{0}^{′′}} - β . & ( 15 )\end{matrix}$$

Using these expressions, the position x_ref_ar2 of the car 6 in the run pattern generated by the second pattern generating unit 29 is represented by expression (16) below as a quartic function of time t [s].

$$\begin{matrix}[ Math . 16 ] & \\ x\_ref \_ar2 ( t ) = \frac{α - β}{24 {T}_{0}^{′′}} {( {T}_{0}^{′′} - t )}^{4} + \frac{β}{6} {( {T}_{0}^{′′} - t )}^{3} . & ( 16 )\end{matrix}$$

As described above, in the run pattern generated by the second pattern generating unit 29, continuity of the acceleration, the speed, and the position of the car 6 is maintained before and after the control mode is switched from the interfloor running mode to the landing mode and between landing modes. Therefore, vibration of the car 6 during landing control is less likely to be induced. In addition, since the running distance in the run pattern generated by the second pattern generating unit 29 matches the distance x₀ [m] between the point-of-origin position and the landing position, a landing error is not created.

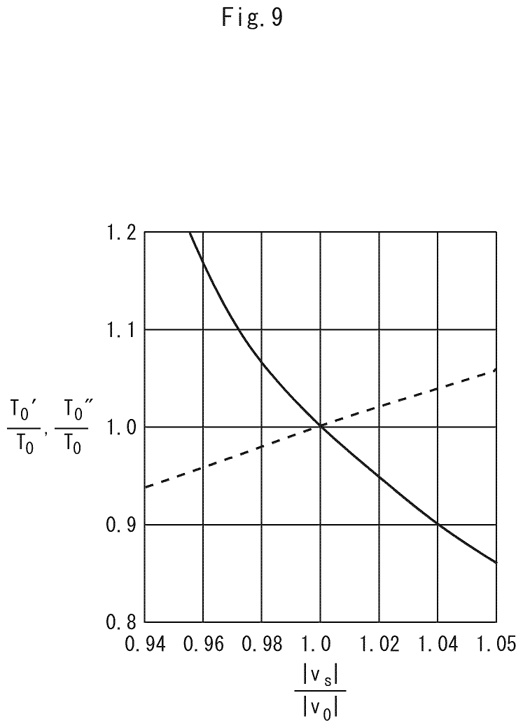

Next, landing times of run patterns respectively generated by the first pattern generating unit 28 and the second pattern generating unit 29 will be described with reference to FIG. 9 to FIG. 11.

FIG. 9 is a diagram showing a relationship between a landing time and a speed of the car 6 in the run pattern generated by the pattern generating unit according to the first embodiment.

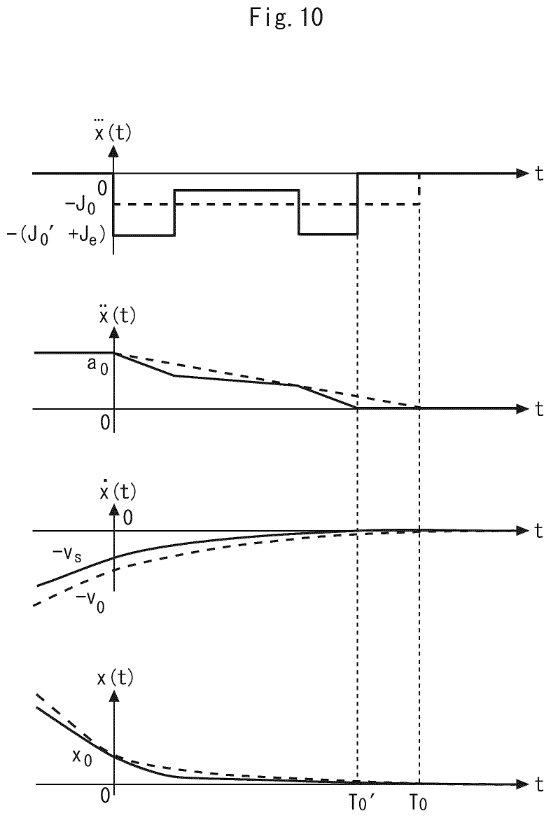

FIG. 10 is a diagram showing an example of a run pattern generated by the first pattern generating unit 28 according to the first embodiment.

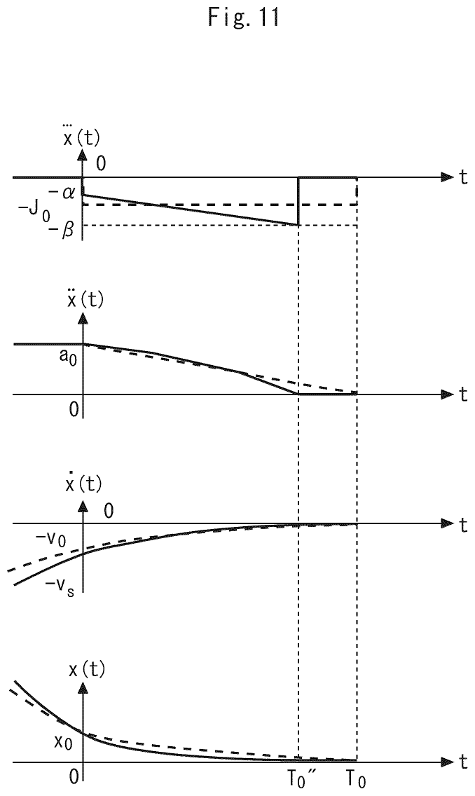

FIG. 11 is a diagram showing an example of a run pattern generated by the first pattern generating unit 28 according to the first embodiment.

In FIG. 9, an axis of ordinate represents a ratio of the landing time T′₀ [s] or T″₀ [s] in each run pattern with respect to a landing time T₀ [s] when it is assumed that there is no error in the present position of the car 6 which is detected by the position measuring unit 10. In this case, an absolute value |vₛ| of an actual speed of the car 6 which is acquired by the sample and hold 27 at a timing when the car 6 passes the point-of-origin position will be referred to as a first speed. An absolute value |v₀| of a speed at a timing when the car 6 passes the point-of-origin position when it is assumed that there is no error in the present position of the car 6 which is detected by the position measuring unit 10 will be referred to as a second speed. In FIG. 9, an axis of abscissa represents a ratio of the first speed |vₛ| with respect to the second speed |v₀|. In FIG. 9, a graph depicted by a dashed line represents a relationship with respect to a run pattern generated by the first pattern generating unit 28. In FIG. 9, a graph depicted by a solid line represents a relationship with respect to a run pattern generated by the second pattern generating unit 29. In the relationships shown in FIG. 9, the point-of-origin position x₀ [m] and the acceleration a₀ [m/s²] of the car 6 when passing the point-of-origin position are fixed at values set in advance.

The landing time T′₀ [s] in the run pattern generated by the first pattern generating unit 28 is represented by expression (4). Therefore, from expression (2), a ratio T′₀/T₀ of landing times monotonically increases with respect to an increase in a ratio |vₛ|/|v₀| of speeds. When the first speed |vₛ| and the second speed |v₀| match each other or, in other words, when |vₛ|/|v₀|=1, the ratio of landing times is T′₀/T₀=1. Accordingly, when the first speed |vₛ| is smaller than the second speed |v₀|, the landing time T′₀ [s] in the run pattern generated by the first pattern generating unit 28 is shorter than the landing time T₀ [s] in the run pattern in which a constant jerk is maintained until the car 6 stops.

The landing time T′₀ [s] in the run pattern generated by the second pattern generating unit 29 is represented by expression (13). Therefore, from expression (2), the ratio T′₀/T₀ of landing times monotonically decreases with respect to an increase in the ratio |vₛ|/|v₀| of speeds. When the first speed |vₛ| and the second speed |v₀| match each other or, in other words, when |vₛ|/|v₀|=1, the ratio of landing times is T′₀/T₀=1. Accordingly, when the first speed |vₛ| is larger than the second speed |v₀|, the landing time T′₀ [s] in the run pattern generated by the second pattern generating unit 29 is shorter than the landing time T₀ [s] in the run pattern in which a constant jerk is maintained until the car 6 stops.

The landing instructing unit 17 includes the first pattern generating unit 28 and the second pattern generating unit 29 as the plurality of pattern generating units. Therefore, the pattern selecting unit 30 selects a run pattern with a shorter landing time among the run patterns respectively generated by the first pattern generating unit 28 and the second pattern generating unit 29. The pattern selecting unit 30 generates the run pattern generated by the first pattern generating unit 28 when the first speed |vₛ| is smaller than the second speed |v₀|. The pattern selecting unit 30 generates the run pattern generated by the second pattern generating unit 29 when the first speed |vₛ| is larger than the second speed |v₀|. Accordingly, the landing time until the car 6 stops is equal to or shorter than the landing time T₀ [s] in the run pattern in which a constant jerk is maintained until the car 6 stops regardless of the magnitudes of the first speed |vₛ| and the second speed |v₀|. In addition, since continuity of acceleration and the like is maintained in the run pattern generated by any pattern generating unit, a decline in ride comfort due to induction of a vibration of the car 6 is suppressed.

In FIG. 10, a run pattern generated by the first pattern generating unit 28 is depicted by a solid line. In addition, the run pattern shown in FIG. 2 in which a constant jerk is maintained until the car 6 stops is depicted by a dashed line. This diagram confirms that, when the first speed |vₛ| is smaller than the second speed |v₀|, the landing time T′₀ [s] in the run pattern generated by the first pattern generating unit 28 is shorter than the landing time T₀ [m] in the run pattern with a constant jerk.

In FIG. 11, a run pattern generated by the second pattern generating unit 29 is depicted by a solid line. In addition, the run pattern shown in FIG. 2 in which a constant jerk is maintained until the car 6 stops is depicted by a dashed line. This diagram confirms that, when the first speed |vₛ| is larger than the second speed |v₀|, the landing time T″₀ [s] in the run pattern generated by the second pattern generating unit 29 is shorter than the landing time T₀ [m] in the run pattern with a constant jerk.

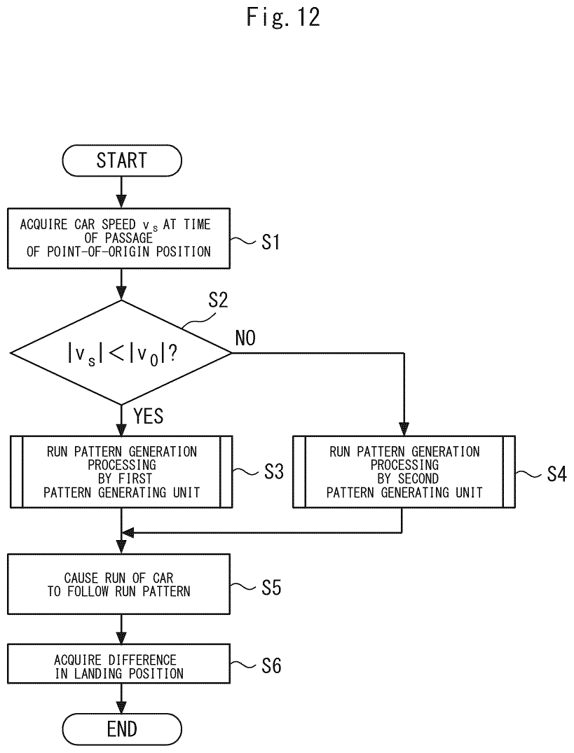

Next, an example of operations of the control system 8 will be described with reference to FIG. 12 to FIG. 14.

FIG. 12 to FIG. 14 are flowcharts showing an example of operations of the control system 8 according to the first embodiment.

FIG. 12 shows an example of processing by the control system 8 related to landing control to a landing position.

The processing of FIG. 12 is started when the point-of-origin detecting unit 11 detects a passage of the point-of-origin position by the car 6.

In step S1, the sample and hold 27 of the landing instructing unit 17 acquires the speed vₛ [m/s] of the car 6 when the car 6 passes the point-of-origin position. Subsequently, the control system 8 advances to processing of step S2.

In step S2, the pattern selecting unit 30 judges whether or not the first speed |vₛ| is smaller than the second speed |v₀|. When a judgment result is Yes, the control system 8 advances to processing of step S3. On the other hand, when a judgment result is No, the control system 8 advances to processing of step S4.

In step S3, the first pattern generating unit 28 performs generation processing of a run pattern. Subsequently, the control system 8 advances to processing of step S5.

In step S4, the second pattern generating unit 29 performs generation processing of a run pattern. Subsequently, the control system 8 advances to processing of step S5.

In step S5, the run control unit 19 causes a run of the car 6 to follow the generated run pattern and stop at a landing position. Subsequently, the control system 8 advances to processing of step S6.

In step S6, after the car 6 stops, the control system 8 acquires a difference between a stop position of the car 6 and the landing position. The difference acquired at this point is used as information for making a judgment on the landing operation. Subsequently, the control system 8 ends the processing related to the landing control.

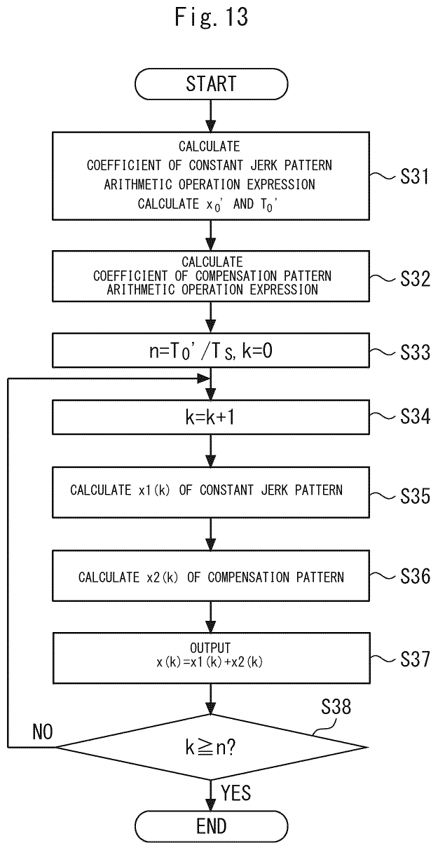

FIG. 13 shows an example of generation processing of a run pattern by the first pattern generating unit 28 in step S3 shown in FIG. 12.

In step S31, the constant jerk pattern generating unit 32 calculates a coefficient in an arithmetic operation expression of the run pattern in which jerk is constant. At this point, the constant jerk pattern generating unit 32 calculates the running distance x′₀ [m] and the landing time T′₀ [s] of the car 6. Subsequently, the first pattern generating unit 28 advances to processing of step S32.

In step S32, the compensation pattern generating unit 33 calculates a coefficient in an arithmetic operation expression of the run pattern which compensates for the landing error xₑ [m] within the landing time T′₀ [s]. Subsequently, the first pattern generating unit 28 advances to processing of step S33.

In step S33, the first pattern generating unit 28 calculates the number of processing times n during a run to the landing position after passing the point-of-origin position. The first pattern generating unit 28 calculates the number of processing times n as a natural number n obtained by dividing the landing time T′₀ [s] by an arithmetic operation cycle Tₛ [s]. The first pattern generating unit 28 initializes a loop variable k to 0. Subsequently, the first pattern generating unit 28 advances to processing of step S34.

In step S34, the first pattern generating unit 28 adds 1 to the loop variable k. Subsequently, in step S35, the constant jerk pattern generating unit 32 calculates a position x1 (k) of the car 6 at a k-th time of day point of the generated run pattern. Subsequently, in step S36, the compensation pattern generating unit 33 calculates a position x2 (k) of the car 6 at a k-th time of day of the generated run pattern. Subsequently, in step S37, the adder 34 adds the position x1 (k) and the position x2 (k) and outputs the position obtained by the addition as a position x (k) of the car 6 at the k-th time of day point of the run pattern generated by the first pattern generating unit 28. Subsequently, in step S38, the first pattern generating unit 28 judges whether or not the loop variable k is equal to or larger than the number of processing times n. When the judgment result is No, the first pattern generating unit 28 advances to processing of step S34. On the other hand, when the judgment result is Yes, the first pattern generating unit 28 ends the generation processing of a run pattern.

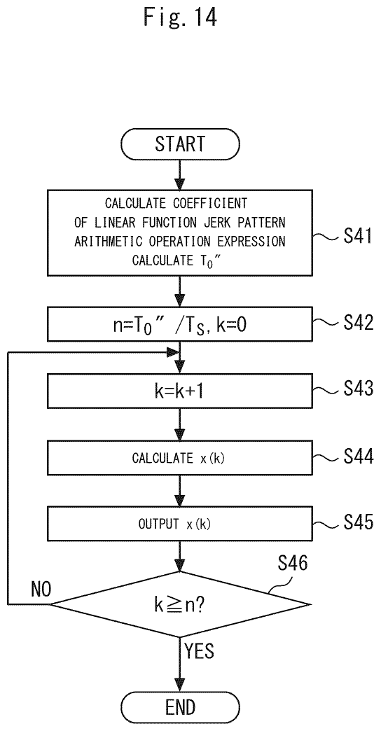

FIG. 14 shows an example of generation processing of a run pattern by the second pattern generating unit 29 in step S4 shown in FIG. 12.

In step S41, the second pattern generating unit 29 calculates a coefficient in an arithmetic operation expression of the run pattern in which an absolute value of jerk increases as a linear function of time. At this point, the second pattern generating unit 29 calculates the landing time T″₀ [s]. Subsequently, the second pattern generating unit 29 advances to processing of step S42.

In step S42, the second pattern generating unit 29 calculates the number of processing times n during a run to the landing position after passing the point-of-origin position. The second pattern generating unit 29 calculates the number of processing times n as a natural number n obtained by dividing the landing time T″₀ [s] by the arithmetic operation cycle Tₛ [s]. The second pattern generating unit 29 initializes the loop variable k to 0. Subsequently, the second pattern generating unit 29 advances to processing of step S43.

In step S43, the second pattern generating unit 29 adds 1 to the loop variable k. Subsequently, in step S44, the second pattern generating unit 29 calculates a position x (k) of the car 6 at a k-th time of day point of the generated run pattern. Subsequently, in step S45, the second pattern generating unit 29 outputs calculated x (k). Subsequently, in step S46, the second pattern generating unit 29 judges whether or not the loop variable k is equal to or larger than the number of processing times n. When the judgment result is No, the second pattern generating unit 29 advances to processing of step S43. On the other hand, when the judgment result is Yes, the second pattern generating unit 29 ends the generation processing of a run pattern.

Note that the control system 8 may include three or more pattern generating units. The pattern generating units may generate a run pattern in which a relationship between a jerk and time is determined by another function such as a step function or a linear function. In this case, as the function, for example, a function set by two or more parameters or the like is selected. In addition, each pattern generating unit may output a speed waveform instead of outputting a position waveform. In this case, the control system 8 can also be applied to the elevator 1 which performs landing control based on speed control.

In addition, the position measuring unit 10 need not be a sensor of an APS. For example, the position measuring unit 10 may be configured to detect a position of the car 6 using a governor or the like.

As described above, the control system 8 according to the first embodiment includes the position measuring unit 10, the point-of-origin detecting unit 11, the plurality of pattern generating units, the run control unit 19, and the pattern selecting unit 30. The position measuring unit 10 detects a present position of the car 6 in a run direction. The point-of-origin detecting unit 11 detects passage of the car 6 at a point-of-origin position which is separated by a distance set in advance from a landing position of the car 6. Each of the pattern generating units generates a run pattern from the point-of-origin position to the landing position based on mutually different algorithms. In each run pattern, the acceleration from before the car 6 passes the point-of-origin position until the car 6 stops is continuous. The run control unit 19 causes the run of the car 6 to follow the run pattern generated by any of the pattern generating units based on the present position of the car 6 which is detected by the position measuring unit 10. The pattern selecting unit 30 selects a run pattern which minimizes a landing time as the run pattern which the run control unit 19 causes the run of the car 6 to follow from among the run patterns generated by the respective pattern generating units. The landing time is a time required by a run from the point-of-origin position to the landing position. The pattern selecting unit 30 makes the selection based on the speed of the car 6 at a timing when the point-of-origin detecting unit 11 detects the passage by the car 6.

In addition, a method for controlling the elevator 1 according to the first embodiment includes a point-of-origin detection step, a speed acquisition step, a pattern selection step, and a run control step. The point-of-origin detection step is a step of detecting passage of the car 6 at the point-of-origin position. The speed acquisition step is a step of acquiring the speed of the car 6 at a timing when the passage of the point-of-origin position by the car 6 is detected in the point-of-origin detection step. The pattern selection step is a step of selecting a run pattern which minimizes a landing time from among a plurality of run patterns based on mutually different algorithms. Each of the run patterns is a run pattern from the point-of-origin position to the landing position. In each of the run patterns, an acceleration from before the car 6 passes the point-of-origin position until the car 6 stops is continuous. In the pattern selection step, a selection is made based on the speed of the car 6 acquired in the speed acquisition step. The run control step is a step of causing a run of the car 6 to follow the run pattern selected in the pattern selection step based on the present position of the car 6.

According to such a configuration, the run of the car 6 is controlled so that acceleration maintains continuity from immediately before the car 6 passes the point-of-origin position until the car 6 stops. Therefore, since a vibration of the car 6 is less likely to be induced, a decline in ride comfort during landing control is suppressed. In addition, since the run pattern which minimizes the landing time is selected from a plurality of run patterns, convenience of a user of the elevator 1 improves. In other words, both a suppression of a decline in ride comfort and an improvement in convenience of a user can be satisfied.

In addition, the control system 8 includes the first pattern generating unit 28 as a pattern generating unit. The first pattern generating unit 28 generates a run pattern by superimposing a constant jerk pattern and a compensation pattern on top of each other. The constant jerk pattern is a run pattern which adopts the speed of the car 6 at a timing when the point-of-origin detecting unit 11 detects the passage of the car 6 as an initial speed and which maintains a constant jerk until the car 6 stops. The compensation pattern is a run pattern to compensate for a landing error due to the constant jerk pattern within a landing time in the constant jerk pattern.

According to such a configuration, a run pattern which compensates for a landing error is generated based on a run pattern according to a constant jerk which provides a user with favorable ride comfort. Therefore, both a suppression of a decline in ride comfort and an improvement in convenience of a user can be satisfied more effectively.

Furthermore, the control system 8 includes the second pattern generating unit 29 as a pattern generating unit. The second pattern generating unit 29 generates a run pattern in which an absolute value of jerk increases as a linear function of time until the car 6 stops in accordance with the speed of the car 6 at a timing when the point-of-origin detecting unit 11 detects the passage of the car 6.

According to such a configuration, a run pattern which provides a user with favorable ride comfort while preventing abrupt changes to the jerk is generated. Therefore, both a suppression of a decline in ride comfort and an improvement in convenience of a user can be satisfied more effectively.

Moreover, an absolute value of the speed of the car 6 at a timing when the point-of-origin detecting unit 11 detects the passage by the car 6 is adopted as a first speed. An absolute value of the speed of the car 6 at the point-of-origin position when it is assumed that there is no error in the present position of the car 6 which is detected by the position measuring unit 10 is adopted as a second speed. The pattern selecting unit 30 selects a run pattern generated by the first pattern generating unit 28 when the first speed is smaller than the second speed. The pattern selecting unit 30 selects a run pattern generated by the second pattern generating unit 29 when the first speed is larger than the second speed.

A relationship between the second speed and the landing time in the run patterns generated by the first pattern generating unit 28 and the second pattern generating unit 29 is represented by a formula according to an elementary function such as expression (4) and expression (13). Therefore, a judgment condition as to which run pattern has a shorter landing time is a condition that can be set in advance based on these expressions or the like. In this example, which run pattern has a shorter landing time can be judged according to a magnitude relationship between the first speed and the second speed. Therefore, at a timing when the car 6 passes the point-of-origin position, the pattern selecting unit 30 can promptly judge which run pattern has a shorter landing time based on the speed of the car 6 at the timing. Accordingly, a time lag related to selection of a run pattern can be reduced. As a result, both a suppression of a decline in ride comfort and an improvement in convenience of a user are satisfied more effectively.

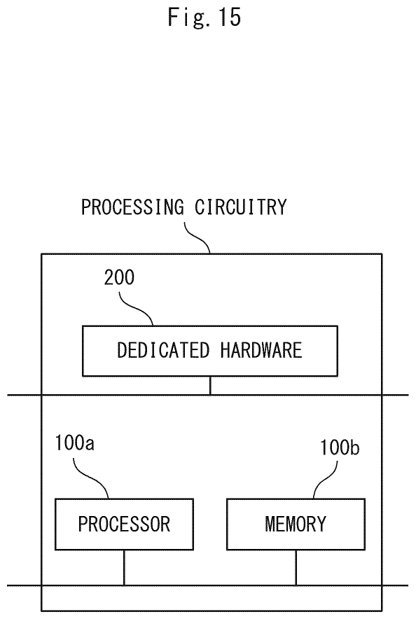

Next, an example of a hardware configuration of the control system 8 will be described with reference to FIG. 15.

FIG. 15 is a hardware block diagram of substantial parts of the control system 8 according to the first embodiment.

Each function of the control system 8 can be realized by a processing circuit. The processing circuit includes at least one processor 100a and at least one memory 100b. The processing circuit may include at least one piece of dedicated hardware 200 together with, or in place of, the processor 100a and the memory 100b.

When the processing circuit includes the processor 100a and the memory 100b, each function of the control system 8 is realized by software, firmware, or a combination of software and firmware. At least one of the software and the firmware is described as a program. The program is stored in the memory 100b. The processor 100a realizes each function of the control system 8 by reading and executing the program stored in the memory 100b.

The processor 100a is also referred to as a CPU (Central Processing Unit), a processing unit, an arithmetic unit, a microprocessor, a microcomputer, or a DSP. The memory 100b is constituted of, for example, a non-volatile or volatile semiconductor memory such as a RAM, a ROM, a flash memory, an EPROM, or an EEPROM.

When the processing circuit includes the piece of dedicated hardware 200, for example, the processing circuit is realized by a single circuit, a combined circuit, a programmed processor, a parallel-programmed processor, an ASIC, an FPGA, or a combination thereof.

Each function of the control system 8 can be individually realized by a processing circuit. Alternatively, respective functions of the control system 8 can be collectively realized by a processing circuit. With respect to the respective functions of the control system 8, a part of the functions may be realized by the piece of dedicated hardware 200 while other parts may be realized by software or firmware. In this manner, the processing circuit realizes each function of the control system 8 using the dedicated hardware 200, software, firmware, or a combination thereof.

### Second Embodiment

In a second embodiment, points which differ from the example disclosed in the first embodiment will be described in detail. Any of the features of the example disclosed in the first embodiment may be adopted as features not described in the second embodiment.

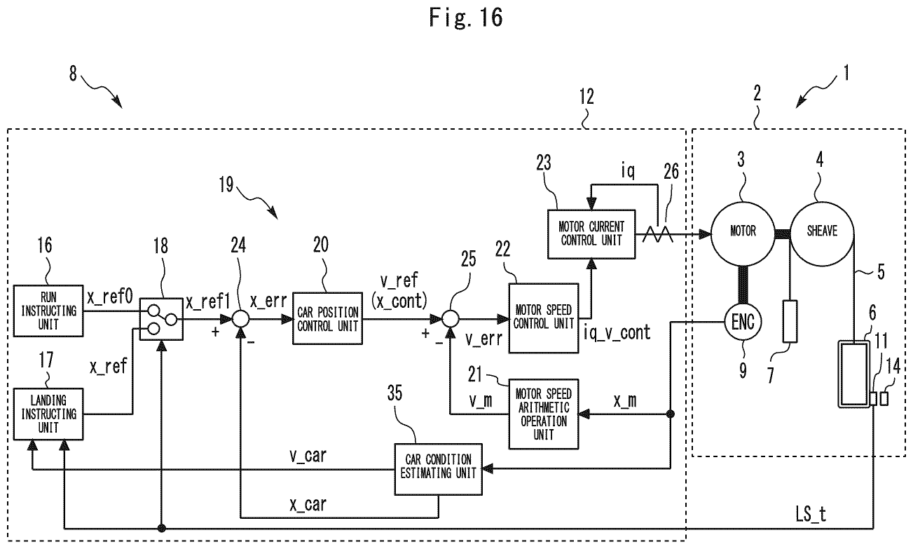

FIG. 16 is a configuration diagram of an elevator 1 according to the second embodiment.

In this example, a control system 8 of the elevator 1 does not include a position measuring unit 10. The control system 8 includes a car condition estimating unit 35 in place of the position measuring unit 10.

The car condition estimating unit 35 is a unit which estimates a condition of the car 6. The car condition estimating unit 35 is mounted to a control device 12. The condition of the car 6 which is estimated by the car condition estimating unit 35 is a present position of the car 6 in a run direction, a speed of the car 6, and the like. The car condition estimating unit 35 is a unit which detects a present position of the car 6 in the run direction by estimation. The car condition estimating unit 35 is an example of the position detecting unit. The car condition estimating unit 35 estimates the present position of the car 6 based on a signal received from an encoder 9. The car condition estimating unit 35 outputs a signal of a detected present position x_car of the car 6 to a subtractor 24 of the control device 12. In addition, the car condition estimating unit 35 estimates the speed of the car 6 according to, for example, a time derivative of the present position of the car 6. The car condition estimating unit 35 outputs a signal of an estimated speed v_car of the car 6 to a landing instructing unit 17 of the control device 12.

Note that the car condition estimating unit 35 may be omitted in an elevator 1 of which an ascending and descending step is short enough that transmission characteristics to the car 6 through a motor 3, a sheave 4, and a main rope 5 can be ignored. In this case, the control system 8 may include a car speed arithmetic operation unit 15 in place of the car condition estimating unit 35. On the other hand, in an elevator 1 of which the ascending and descending step is long enough that transmission characteristics to the car 6 through the motor 3, the sheave 4, and the main rope 5 cannot be ignored, the condition estimating unit is constituted of, for example, a secondary filter.

Even in such a configuration, the run of the car 6 is controlled so that acceleration maintains continuity from immediately before the car 6 passes the point-of-origin position until the car 6 stops. Therefore, since a vibration of the car 6 is less likely to be induced, a decline in ride comfort during landing control is suppressed. In addition, since the run pattern which minimizes the landing time is selected from a plurality of run patterns, convenience of a user of the elevator 1 improves. In other words, both a suppression of a decline in ride comfort and an improvement in convenience of a user can be satisfied.

### INDUSTRIAL APPLICABILITY

The control system and the control method according to the present disclosure can be applied to an elevator.

### REFERENCE SIGNS LIST

1 Elevator, 2 Hoistway, 3 Motor, 4 Sheave, 5 Main rope, 6 Car, 7 Counterweight, 8 Control system, 9 Encoder, 10 Position measuring unit, 11 Point-of-origin detecting unit, 12 Control device, 13 Code tape, 14 Detection object, 15 Car speed arithmetic operation unit, 16 Run instructing unit, 17 Landing instructing unit, 18 Control mode switching unit, 19 Run control unit, 20 Car position control unit, 21 Motor speed arithmetic operation unit, 22 Motor speed control unit, 23 Motor current control unit, 24, 25 Subtractor, 26 Current detector, 27 Sample and hold, 28 First pattern generating unit, 29 Second pattern generating unit, 30 Pattern selecting unit, 31 Pattern switching unit, 32 Constant jerk pattern generating unit, 33 Compensation pattern generating unit, 34 Adder, 35 Car condition estimating unit, 100a Processor, 100b Memory, 200 Hardware.

1-5. (canceled)

6. An elevator control system, comprising:
a position detector which detects a present position of a car in a run direction;
a point-of-origin detector which detects passage of the car at a point-of-origin position which is separated by a distance set in advance from a landing position of the car;
a plurality of pattern generators, each of which generates, based on mutually different algorithms, a run pattern from the point-of-origin position to the landing position in which acceleration is continuous from before the car passes the point-of-origin position until the car stops;
a run controller which causes a run of the car to follow a run pattern generated by any of the plurality of pattern generators based on a present position of the car which is detected by the position detector; and
a pattern selector which selects a run pattern that minimizes a landing time required by a run from the point-of-origin position to the landing position as the run pattern which the run controller causes the run of the car to follow from among the run patterns respectively generated by the plurality of pattern generating units based on a speed of the car at a timing when the point-of-origin detector detects a passage of the car.

7. The elevator control system according to claim 6, wherein the plurality of pattern generators include a first pattern generator which generates a run pattern by superimposing, on top of each other, one pattern which adopts a speed of the car at a timing when the point-of-origin detector detects a passage of the car as an initial speed and which maintains a constant jerk until the car stops and another pattern which compensates for a landing error due to the one pattern during a landing time in the one pattern.

8. The elevator control system according to claim 6, wherein the plurality of pattern generators include a second pattern generator which generates a run pattern in which an absolute value of jerk increases as a linear function of time until the car stops in accordance with the speed of the car at a timing when the point-of-origin detector detects the passage of the car.

9. The elevator control system according to claim 7, wherein the plurality of pattern generators include a second pattern generator which generates a run pattern in which an absolute value of jerk increases as a linear function of time until the car stops in accordance with the speed of the car at a timing when the point-of-origin detector detects the passage of the car.

10. The elevator control system according to claim 6, wherein
the plurality of pattern generators include:
a first pattern generator which generates a run pattern by superimposing, on top of each other, one pattern which adopts a speed of the car at a timing when the point-of-origin detector detects a passage of the car as an initial speed and which maintains a constant jerk until the car stops and another pattern which compensates for a landing error due to the one pattern during a landing time in the one pattern; and
a second pattern generator which generates a run pattern in which an absolute value of jerk increases as a linear function of time until the car stops in accordance with the speed of the car at a timing when the point-of-origin detector detects the passage of the car, and
the pattern selector adopts an absolute value of the speed of the car at a timing when the point-of-origin detector detects a passage by the car as a first speed, adopts an absolute value of the speed of the car at the point-of-origin position when it is assumed that there is no error in the present position of the car which is detected by the position detector as a second speed, selects a run pattern generated by the first pattern generator when the first speed is smaller than the second speed, and selects a run pattern generated by the second pattern generator when the first speed is larger than the second speed.

11. A method for controlling an elevator, comprising:
detecting passage of a car at a point-of-origin position which is separated by a distance set in advance from a landing position of the car;
acquiring the speed of the car at a timing when the passage of the point-of-origin position by the car is detected;
selecting a run pattern which minimizes a landing time required by a run from the point-of-origin position to the landing position based on the acquired speed of the car from a plurality of run patterns based on mutually different algorithms from the point-of-origin position to the landing position in which acceleration is continuous from before the car passes the point-of-origin position until the car stops; and
causing a run of the car to follow the selected run pattern based on a present position of the car.
